(19) United States
(12) Patent Application Publication
(10) Pub. No.: US 2026/0352768 A1
(43) Pub. Date: Nov. 5, 2026

(54) SHEET CONVEYANCE APPARATUS, IMAGE READING APPARATUS, AND IMAGE FORMING APPARATUS

(71) Applicant: CANON KABUSHIKI KAISHA, Tokyo (JP)

(72) Inventor: Riki Miyakawa, Chiba (JP)

(21) Appl. No.: 19/652,039

(22) Filed: Apr. 20, 2026

(30) Foreign Application Priority Data
May 2, 2025 (JP) 2025-076833
Mar. 10, 2026 (JP) 2026-038079

(51) Int. Cl. H04N 1/00

(52) U.S. Cl. CPC H04N 1/00615; H04N 1/00554; H04N 1/00559; H04N 1/00588

(57) ABSTRACT

A sheet conveyance apparatus includes a conveyance portion including a conveyance path configured to guide a sheet being conveyed such that the sheet passes through a reading position of a reading portion, and an opposing unit arranged to be opposed to the transparent member. The opposing unit includes a guide main body made of resin and including an opposing portion, a reinforcing member made of metal, a single fastening portion configured to fasten the guide main body and the reinforcing member; and a restricting portion configured to restrict the guide main body and the reinforcing member from separating. The fastening portion is disposed at one location, and the restricting portion disposed at a position different from the fastening portion in the longitudinal direction.

### BACKGROUND

### Field of the Technology

The present disclosure relates to a sheet conveyance apparatus for conveying sheets, an image reading apparatus, and an image forming apparatus.

### Description of the Related Art

Regarding an image reading apparatus of an image forming apparatus, there is known a technique in which a document is conveyed to a document feeding-reading glass of an image reading portion by a document conveyance unit to read an image on the document (refer to Japanese Patent Application Laid-Open Publication No. 2016-181771). According to the image reading apparatus disclosed in Japanese Patent Application Laid-Open Publication No. 2016-181771, a platen guide that is arranged to be opposed to the document feeding-reading glass is provided such that the document is not lifted from an upper surface of the document feeding-reading glass.

### SUMMARY

Regarding a guide that is arranged to be opposed to the document feeding-reading glass, as in the case of the platen guide as disclosed in Japanese Patent Application Laid-Open Publication No. 2016-181771, if a positional accuracy of the guide with respect to the document feeding-reading glass is not good, the quality of the read image may be deteriorated.

According to a first aspect of the present disclosure, a sheet conveyance apparatus includes a conveyance portion including a conveyance path configured to guide a sheet being conveyed such that the sheet passes through a reading position of a reading portion at which an image on the sheet is read via a transparent member, and an opposing unit arranged to be opposed to the transparent member and configured to form a portion of the conveyance path. The opposing unit includes a guide main body made of resin and including an opposing portion arranged to be opposed to a surface of the transparent member, a reinforcing member made of metal, configured to extend in a longitudinal direction of the guide main body, and attached to the guide main body on an opposite side from the transparent member, a single fastening portion configured to fasten the guide main body and the reinforcing member; and a restricting portion configured to restrict the guide main body and the reinforcing member from separating. The fastening portion is disposed at one location, and the restricting portion disposed at a position different from the fastening portion in the longitudinal direction.

According to a second aspect of the present disclosure, a sheet conveyance apparatus includes a conveyance portion including a conveyance path configured to guide a sheet being conveyed such that the sheet passes through a reading position of a reading portion at which an image on the sheet is read via a transparent member, and an opposing unit arranged to be opposed to the transparent member and configured to form a portion of the conveyance path. the opposing unit includes a guide main body made of resin and including an opposing portion arranged to be opposed to a surface of the transparent member, a reinforcing member made of metal, configured to extend in a longitudinal direction of the guide main body, and attached to the guide main body on an opposite side from the transparent member, a fastening portion configured to fasten the guide main body and the reinforcing member, and a first and second restricting portions disposed at positions respectively different from the fastening portion in the longitudinal direction and configured to restrict the guide main body and the reinforcing member from separating. The reinforcing member includes a first end portion, a second end portion, and a center portion disposed between the first end portion and the second end portion, which are three equal parts in the longitudinal direction of the reinforcing member. The fastening portion is configured to fasten the guide main body and the center portion of the reinforcing member. The first restricting portion is configured to restrict the guide main body and the first end portion of the reinforcing member from separating, and the second restricting portion is configured to restrict the guide main body and the second end portion of the reinforcing member from separating.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view illustrating an image forming apparatus according to the present embodiment.

FIG. 2 is an external perspective view illustrating the image reading apparatus according to the present embodiment.

FIG. 3 is a schematic cross-sectional view illustrating the image reading apparatus according to the present embodiment.

FIG. 4 is a perspective view illustrating the image reading apparatus in a state where an ADF is opened according to the present embodiment.

FIG. 5 is a cross-sectional view illustrating a document feeding-reading glass, a surface reading portion, and a swing guide unit according to the present embodiment.

FIG. 6 is a perspective view illustrating a lower side of the swing guide unit according to the present embodiment.

FIG. 7 is a perspective view illustrating an upper side of the swing guide unit according to the present embodiment.

FIG. 8A is an upper side view illustrating the swing guide unit according to the present embodiment.

FIG. 8B is a cross-sectional view taken at arrow A-A of FIG. 8A.

FIG. 8C is an enlarged view of broken line frame B of FIG. 8B.

FIG. 8D is an enlarged view of broken line frame C of FIG. 8B.

FIG. 9 is a cross-sectional view illustrating a swing guide unit according to another embodiment.

### DESCRIPTION OF THE EMBODIMENTS

The present embodiment will be described below with reference to the drawings.

### Schematic Configuration of Image Forming Apparatus

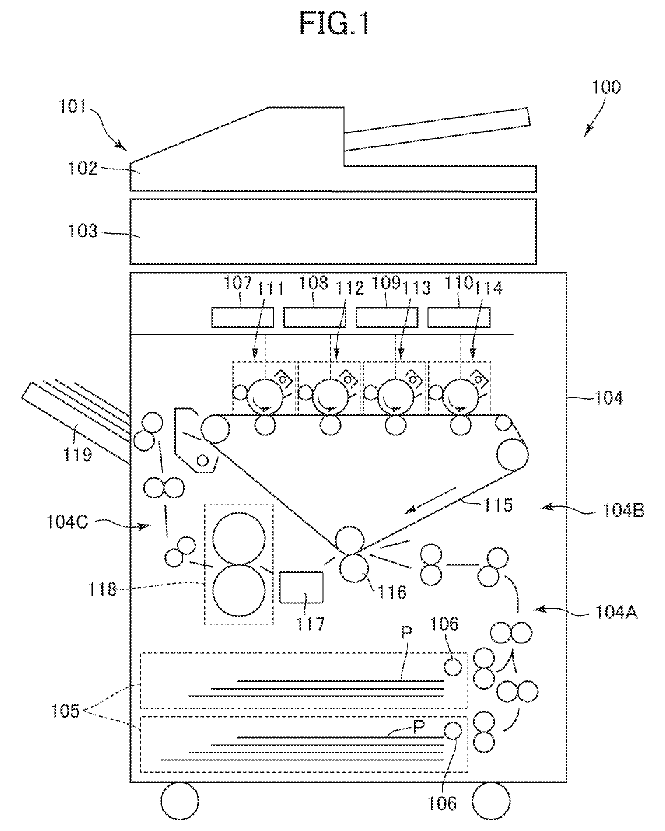

At first, a schematic configuration of an image forming apparatus 100 according to the present embodiment will be described with reference to FIG. 1. FIG. 1 is a schematic cross-sectional view illustrating an image forming apparatus according to the present embodiment.

As illustrated in FIG. 1, the image forming apparatus 100 includes an image reading apparatus 101 capable of reading an image on a document, and an image forming apparatus body 104 capable of forming an image read by the image reading apparatus 101 on a sheet P. As described in detail below, the image reading apparatus 101 includes an image reading portion 103 for reading an image on a document, and an automatic document feeder, hereinafter referred to as ADF, 102 capable of automatically feeding a document to the image reading portion 103. The image reading apparatus 101 is disposed above the image forming apparatus body 104. The image forming apparatus 100 illustrated in FIG. 1 is a laser beam printer adopting an electrophotographic system, but the image reading apparatus 101 according to the present embodiment may similarly be applied to an image forming apparatus adopting an inkjet system or other image forming methods as the image forming unit.

The image forming apparatus body 104 includes, in general, a feeding unit 104A that feeds the sheet P, an image forming unit 104B that forms an image on the sheet P fed by the feeding unit 104A, and a sheet discharge unit 104C that discharges the sheet P on which an image has been formed by the image forming unit 104B.

The feeding unit 104A includes cassettes 105 and 105 that support and accommodate a plurality of sheets P, and feed rollers 106 and 106 that pick up and start feeding of the sheet P from the cassettes 105 and 105. The sheet P fed by the feed roller 106 is fed toward a secondary transfer roller 116 of the image forming unit 104B.

The image forming unit 104B is composed of laser scanners 107, 108, 109, and 110, image forming units 111, 112, 113 and 114, an intermediate transfer belt 115, a secondary transfer roller 116, a pre-fixing conveyance unit 117, and a fixing unit 118. The image forming unit 111 develops an electrostatic latent image exposed by the laser scanner 107 into a yellow (Y) toner image and primarily transfers the image to the intermediate transfer belt 115. Similarly, the image forming unit 112 develops an electrostatic latent image exposed by the laser scanner 108 into a magenta (M) toner image and primarily transfers the image to the intermediate transfer belt 115. Similarly, the image forming unit 113 develops an electrostatic latent image exposed by the laser scanner 109 into a cyan (C) toner image and primarily transfers the image to the intermediate transfer belt 115. Similarly, the image forming unit 114 develops an electrostatic latent image exposed by the laser scanner 110 into a black (K) toner image and primarily transfers the image to the intermediate transfer belt 115. Thereby, a full-color toner image is formed on the surface of the intermediate transfer belt 115.

The full-color toner image transferred to the surface of the intermediate transfer belt 115 is conveyed to the secondary transfer roller 116, and secondarily transferred to the surface of the sheet P fed from the feeding unit 104A by the secondary transfer roller 116. The sheet P to which the toner image has been transferred is conveyed by a conveyor belt not shown via the pre-fixing conveyance unit 117 that conveys the sheet to the fixing unit 118. Then, the toner image is fixed to the sheet P by having the sheet P heated and pressed by the fixing unit 118. Thereafter, the sheet P having the toner image fixed thereto is conveyed by the sheet discharge unit 104C and discharged onto a sheet discharge tray 119.

The configuration of the image forming apparatus body 104 described above is merely an example, and various modifications are possible. For example, the image forming apparatus may include a reverse portion for reversing the upper and lower sides of the sheet, and a reconveyance path for reconveying the sheet to the secondary transfer roller 116 so as to realize duplex printing. Further, the image forming apparatus may be configured to have the toner image directly transferred to the sheet from the image forming unit, or to have a monochrome image formed thereto. Further, the image forming apparatus may include a manual feed tray through which a sheet may be fed manually.

### Configuration of Image Reading Apparatus

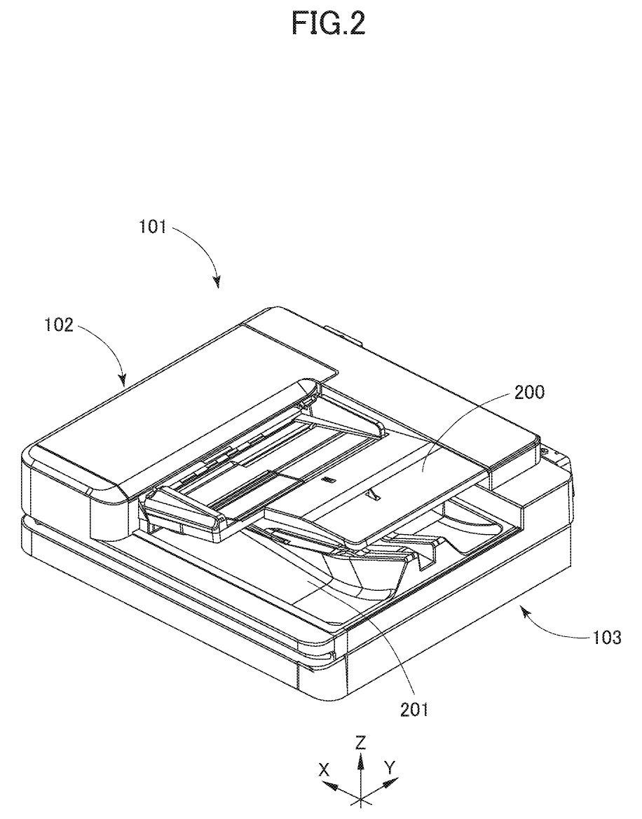

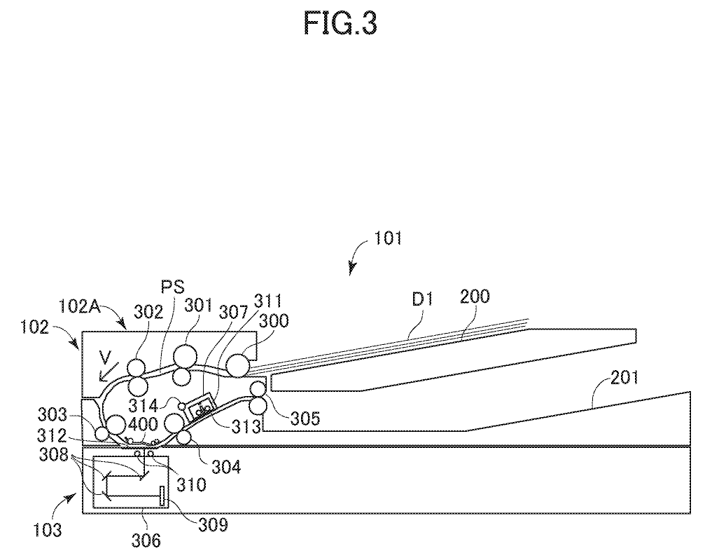

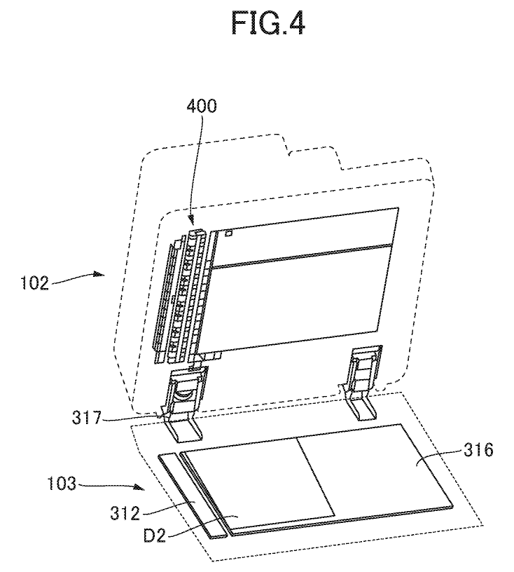

Next, the configuration of the image reading apparatus 101 according to the present embodiment will be described with reference to FIGS. 2, 3, and 4. FIG. 2 is an external perspective view illustrating an image reading apparatus according to a first embodiment. FIG. 3 is a schematic cross-sectional view illustrating the image reading apparatus according to the present embodiment. FIG. 4 is a perspective view illustrating the image reading apparatus in a state where the ADF is opened according to the present embodiment. As illustrated in FIG. 2, in a state where the ADF 102 is closed with respect to the image reading portion 103, the three-dimensional directions regarding the image forming apparatus 100 and the ADF 102 are a right-left direction X, a width direction Y, and an up-down direction Z. The width direction Y is a direction orthogonal to a conveyance direction V, and it also corresponds to a front-rear direction. Further, in general, a front direction in the image forming apparatus 100 is a direction toward which an operation panel not shown faces.

As illustrated in FIGS. 2 and 3, the image reading apparatus 101 includes the image reading portion 103 and the ADF 102, as described above. The ADF 102 includes a document tray 200 on which a document D1 is to be placed and that serves as a document supporting portion for supporting the document D1, and a sheet discharge tray 201 that serves as a discharged document supporting portion or a discharged sheet supporting portion that supports the document D1 being discharged by receiving the discharged document D1 from which the image has been read. Thee ADF 102 further includes a document conveyance portion 102A serving as a conveyance portion that conveys the document D1 from the document tray 200 to the sheet discharge tray 201.

That is, the ADF 102 conveys the document D1 toward a document feeding-reading glass 312 of the image reading portion 103. Meanwhile, the image reading portion 103 includes a surface reading portion 306 that serves as a reading portion for reading an image on a surface of a document being conveyed by the ADF 102. In other words, the document conveyance portion 102A of the ADF 102 conveys the document supported on the document tray 200 such that the document passes through a reading position of the surface reading portion 306, and discharges the document D1 onto the sheet discharge tray 201.

The sheet discharge tray 201 is arranged such that at least a portion thereof is overlapped with the document tray 200 when viewed in the up-down direction, in other words, the sheet discharge tray 201 is arranged below the document tray 200. Therefore, the document conveyance portion 102A has a conveyance path PS that guides the document from the document tray 200 to the sheet discharge tray 201, that has a curved shape that is curved when viewed in a width direction orthogonal to the conveyance direction, and that has a U-shape as an entirety. As described, by forming the conveyance path PS to have a U-shape, in a state where the user sets a document including a plurality of sheets on the document tray 200, the sheets can be discharged onto the sheet discharge tray 201 in page order of the document being set. Further, by arranging the sheet discharge tray 201 below the document tray 200, the ADF 102 can be downsized.

Further, as illustrated in FIG. 4, the ADF 102 is supported pivotably with respect to the image reading portion 103 via a hinge mechanism 317 such that the document feeding-reading glass 312 and a platen glass 316 serving as transparent members that transmit light may be opened.

The document conveyance portion 102A includes a pickup roller 300, a separation roller pair 301, conveyance roller pairs 302, 303, and 304, and a sheet discharge roller pair 305, which are arranged along the conveyance path PS. Further, the document conveyance portion 102A includes a back surface reading portion 307 serving as a reading portion for reading an image on a back surface of a document. The back surface reading portion 307 includes a back surface reading sensor case 314 and a reading glass 313. The back surface reading portion 307 is configured to include, inside the back surface reading sensor case 314, a lighting 315 that irradiates light on the document via the reading glass 313, and a reading sensor 311 that reads images based on a reflected light from the document. According to the present embodiment, the reading sensor 311 is composed of a CIS, but the preset technique is not limited thereto, and any sensor capable of reading an image may be adopted.

Meanwhile, the image reading portion 103 includes the document feeding-reading glass 312, the platen glass 316 (refer to FIG. 4), and the surface reading portion 306 for reading the surface of a document. The surface reading portion 306 includes a lighting 310 that irradiates light on the document via the document feeding-reading glass 312, a plurality of mirrors 308 that reflect and guide reflected light from the document, and a reading sensor 309 that reads the image based on the reflected light. In the present embodiment, the reading sensor 309 is composed of a CMOS sensor, but the present technique is not limited thereto, and any sensor may be adopted as long as the image may be read.

The image reading apparatus 101 can read an image from the document by a feeding-reading mode in which the document D1 placed on the document tray 200 is fed via the ADF 102 while the document image is scanned, and a fixed reading mode in which a document D2 placed on the platen glass 316 is scanned. The feeding-reading mode is selected in a case where the document D1 supported on the document tray 200 is detected by a document presence detection sensor not shown, or in a case where the user clearly instructs the same, for example through an operation panel on the image forming apparatus body 104.

When the feeding-reading mode is executed, the uppermost document D1 set on the document tray 200 is fed by the pickup roller 300, and separated one by one at a separation nip of the separation roller pair 301. Thereafter, the document is conveyed by conveyance roller pairs 302 and 303, conveyed to pass through the surface of the document feeding-reading glass 312, and then conveyed to pass through the reading glass 313 of the back surface reading portion 307 thereafter.

The image on the surface of the document D1 is read by the surface reading portion 306 via the document feeding-reading glass 312, and the image on the back surface of the document D1 is read by the back surface reading portion 307. The image information subjected to photoelectric conversion by light receiving elements of the reading sensor 309 of the surface reading portion 306 and the reading sensor 311 of the back surface reading portion 307 is transferred to a control unit not shown of the image forming apparatus body 104. Then, the document D1 having passed through the document feeding-reading glass 312 is discharged by the sheet discharge roller pair 305 onto the sheet discharge tray 201.

Meanwhile, the fixed reading mode is selected in a case where the document D2 supported on the platen glass 316 (refer to FIG. 4) is detected by the apparatus, or in a case where the user clearly instructs the same, for example through an operation panel on the image forming apparatus body 104. In this case, the document on the platen glass 316 is not moved, and the surface reading portion 306 moves along the platen glass 316 to scan the document. Similarly, the image information subjected to photoelectric conversion by the light receiving element of the reading sensor 309 of the surface reading portion 306 is transferred to a control unit not shown.

The present embodiment was described as having the back surface reading portion 307, but the present technique is not limited to having the back surface reading portion 307. Further, as another embodiment, the image reading portion 103 may include a reading portion for executing the feeding-reading mode and a reading portion for executing the fixed reading mode independently.

### Configuration of Swing Guide Unit

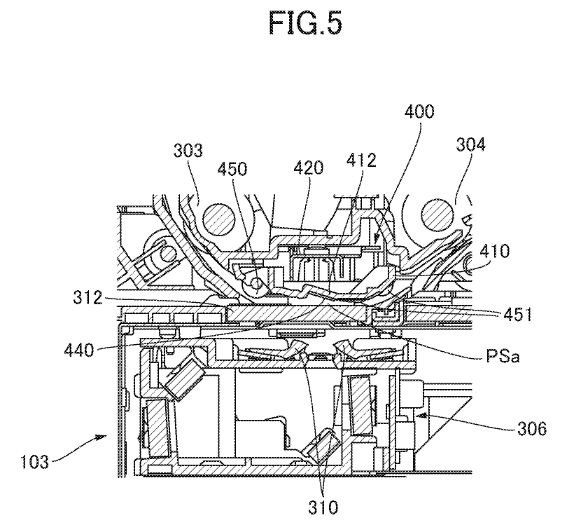

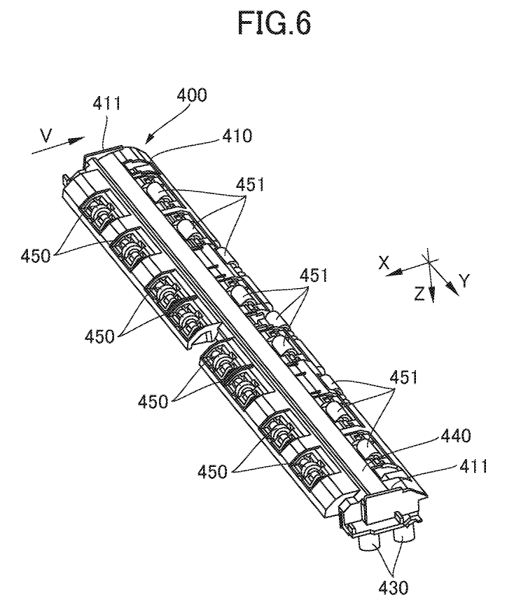

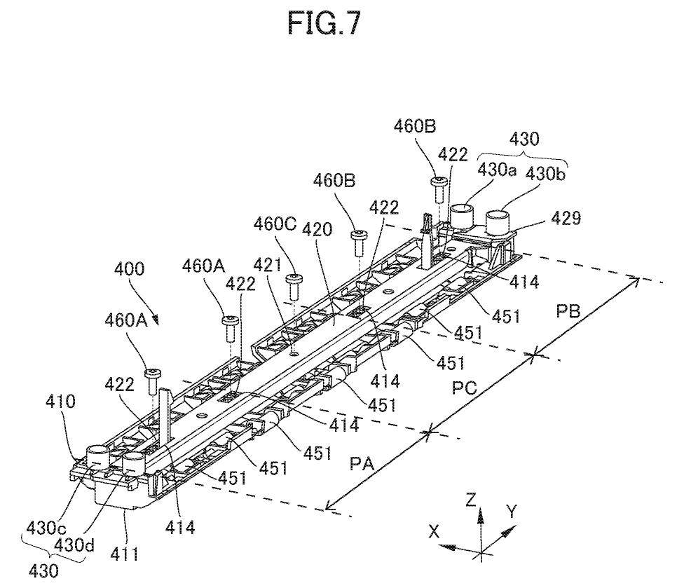

Next, a configuration of a swing guide unit 400 serving as an opposing unit according to the present embodiment will be described with reference to FIGS. 5, 6, and 7. FIG. 5 is a cross-sectional view illustrating the document feeding-reading glass, the surface reading portion, and a swing guide unit according to the present embodiment. FIG. 6 is a perspective view illustrating a lower side of the swing guide unit according to the present embodiment. FIG. 7 is a perspective view illustrating an upper part of the swing guide unit according to the present embodiment.

The swing guide unit 400 according to the present embodiment is arranged above and at a position opposed to the document feeding-reading glass 312, as illustrated in FIG. 5. The swing guide unit 400 is supported swingably with respect to a frame not shown, wherein an abutment portion 411 described in detail below is abutted against the document feeding-reading glass 312, by which the position of the swing guide unit 400 is determined. The swing guide unit 400 forms a narrow space PSa serving as a conveyance space with the document feeding-reading glass 312 at a reading position of the surface reading portion 306, which constitutes a portion of the conveyance path PS and having a smaller height in a thickness direction than the other portions of the conveyance path PS. Thereby, the position of the document D1 when the image on the surface of the document D1 is read by the surface reading portion 306 is restricted.

In general, both a metal material such as sheet metal or a resin material can be adopted as a guide main body of the swing guide unit, wherein if the guide main body is made of metal, the guide main body will not be easily warped and will have sufficient strength, but it cannot be formed to have a complex shape as in the case of the guide main body made of resin. Therefore, there is a drawback that the guide main body cannot be easily formed to have a shape that restricts the document D1 to be positioned at a desired position. Meanwhile, the guide main body made of resin has an advantage in that it can be molded into a complex shape. Therefore, it may be preferable to adopt resin, but it also has a drawback in that component tolerance is increased by warping during formation, or in that deformation occurs by reaction force of the sheet or by environmental changes such as temperature changes. As described, if accuracy of components of the guide main body of the swing guide unit is not good, the conveyance path may be narrowed, such that skewing of documents may occur, which may lead to blocking of the conveyance path, by which sheet jamming may occur. Furthermore, quality of the read image may be deteriorated by erroneously detecting a shadow of the leading edge of the document.

Therefore, according to the present embodiment, a resin material is adopted as a guide main body 410 of the swing guide unit 400. By attaching a reinforcing member 420 made of metal to the guide main body 410 made of resin on a side opposite to the side having the document feeding-reading glass 312, deformation of the guide main body 410 is suppressed. However, by attaching the reinforcing member 420 to the guide main body 410, influences by warping during molding or by component tolerance may occur, such that an attachment structure as described below is adopted. According further to the present embodiment, a resin material is adopted as the guide main body 410, such that complex shapes may be formed, and therefore, attachment of a driven roller 450 as described in detail below is also enabled. The swing guide unit 400 configured in this manner will be descried in detail below.

As illustrated in FIGS. 6 and 7, the swing guide unit 400 includes, in general, the guide main body 410, the reinforcing member 420, springs 430 serving as urging members, a white color member 440, and driven rollers 450 and 451. The guide main body 410 includes an inclined portion 412 (refer to FIG. 5) having an inclined surface shape serving as an opposing portion opposed to the document feeding-reading glass 312 in a state disposed on the ADF 102, and the white color member 440 formed of a white color member is attached to the inclined portion 412. In a state where the light from the lighting 310 of the surface reading portion 306 is irradiated on the leading edge of the document D1, the shadow of the leading edge of the document D1 is projected on the white color member 440. By detecting the image of the shadow of the leading edge of the document D1 projected on the white color member 440 by the surface reading portion 306, the skewing of the document D1 may be detected, and skewing of the read image may be corrected.

Further, on the guide main body 410, two abutment portions 411 are formed to protrude downward from the white color member 440 at both end portions on an outer side in the width direction Y, i.e., front-rear direction, than the inclined portion 412, i.e., the white color member 440. The two abutment portions 411 are arranged at a distance wider than a width size of maximum readable document size readable by the image reading apparatus 101, that is, arranged outside a conveyance area such that a maximum size document may pass through.

Meanwhile, as illustrated in FIG. 7, a plurality of, which according to the present embodiment is four, springs 430a, 430b, 430c, 430d serving as urging portions are disposed above the abutment portion 411 at both end portions in the width direction of the guide main body 410 of the swing guide unit 400. Among them, a first end of the springs 430a and 430b is abutted against a frame being grounded not shown, receiving reaction force therefrom and also being electrically conducted therewith. The second end of the springs 430a and 430b is in contact with and is electrically connected with a washer portion 429 serving as a conduction portion that is formed integrally with the reinforcing member 420 described in detail below. Accordingly, the reinforcing member 420 is earthed and can remove static electricity accumulated in the swing guide unit 400. If there is no need to distinguish the springs 430a, 430b, 430c, 430d, they are simply referred to as the springs 430.

As described, a plurality of springs 430 are disposed between a frame not shown and the guide main body 410, i.e., the washer portion 429 of the reinforcing member 420. Therefore, regarding the swing guide unit 400, the guide main body 410 is urged toward the document feeding-reading glass 312 by the urging force of the springs 430, and the abutment portion 411 is abutted against the document feeding-reading glass 312. Thereby, as illustrated in FIG. 5, a gap between the swing guide unit 400, specifically, the white color member 440, and the document feeding-reading glass 312 is ensured. The gap has a height in the thickness direction that is narrower than the other portions of the conveyance path PS, by which the narrow space PSa is formed as described above, such that the position of the document D1 is restricted in a case where the image on the document D1 is read as described above.

Further, as illustrated in FIGS. 6 and 7, the guide main body 410 includes the driven roller 450 serving as a plurality of rotary members, i.e., first rotary members, that are disposed adjacent to the white color member 440 at a side upstream of the white color member 440 in the conveyance direction V and aligned in the width direction Y. Further, the guide main body 410 includes a driven roller 451 serving as a plurality of rotary members, i.e., second rotary members, that are disposed adjacent to the white color member 440 at a side downstream of the white color member 440 in the conveyance direction V and aligned in two rows in the width direction Y. The guide main body 410 will come into contact with the document D1 to correct the position of the document D1 with respect to the document feeding-reading glass 312, such that conveyance resistance occurs. However, the driven rollers 450 and the driven rollers 451 are driven to be rotated by a document D conveyed by conveyance roller pairs 303 and 304, such that the slide resistance caused when the document D slides against the guide main body 410 may be reduced. As described above, by forming the guide main body 410 from a resin material, it becomes possible to form a complex shape, such as having accommodating holes for accommodating and supporting the driven rollers 450 and 451.

As illustrated in FIG. 7, the reinforcing member 420 made of metal is attached to the guide main body 410, such that deformation of the guide main body 410 may be suppressed. The reinforcing member 420 is composed of a flat metal plate that is bent in a U-shape when viewed in the width direction Y, and in which the width direction Y thereof is extended as a longitudinal direction that is longer than the short direction corresponding to the right-left direction X. The reinforcing member 420 is shaped such that it has a higher rigidity in a deflecting direction with respect to the width direction Y. In other words, the reinforcing member 420 made of metal reinforces the guide main body 410 made of resin such that the guide main body 410 maintains a parallel shape with respect to the document feeding-reading glass 312. The washer portion 429 serving as a conduction portion is formed integrally with the first end of the reinforcing member 420 in the width direction Y, and as described above, the springs 430a and 430b come into contact with the washer portion 429.

### Attachment Configuration of Guide Main Body and Reinforcing Member

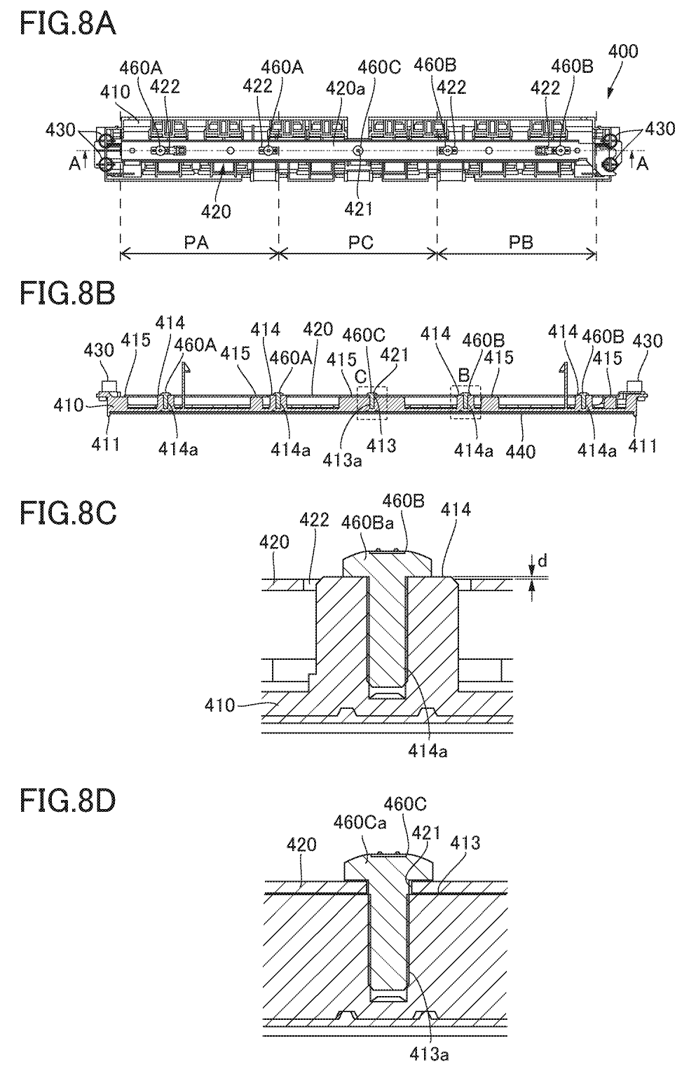

Next, an attachment structure of the guide main body 410 and the reinforcing member 420 in the swing guide unit 400 according to the present embodiment will be described with reference to FIGS. 7 to 8D. FIG. 8A is an upper side view illustrating the swing guide unit according to the present embodiment. FIG. 8B is a cross-sectional view taken at arrow A-A of FIG. 8A. FIG. 8C is an enlarged view of broken line frame B of FIG. 8B. FIG. 8D is an enlarged view of broken line frame C of FIG. 8B.

As illustrated in FIGS. 7, 8A, and 8B, the guide main body 410 includes a fastened portion 413 disposed approximately at a center thereof in the width direction Y, i.e., longitudinal direction, and a plurality of projected portions 414, i.e., two on each side, between end portions in the width direction Y serving as the longitudinal direction of the reinforcing member 420 with respect to the fastened portion 413. Further, as illustrated in FIG. 8B, the guide main body 410 includes a plurality of contact portions 415 that come into contact with the reinforcing member 420 formed to extend from the inclined portion 412 at five locations with an interval therebetween in the width direction Y, i.e., as the longitudinal direction. The contact portions 415 disposed near the center in the width direction Y among the plurality of contact portions 415 are formed continuously and integrally with the fastened portion 413.

As illustrated in FIGS. 7, 8A, 8B, and 8D, a screw hole 421 serving as a second through hole formed on an upper surface 420a of the reinforcing member 420 is formed to pass through the reinforcing member. Further, the fastened portion 413 of the guide main body 410 is formed to extend from the inclined portion 412 (refer to FIG. 5) to come into contact with the circumference of the screw hole 421. Further, a screw hole 413a onto which a screw 460C serving as a second screw is screw-engaged is formed to the fastened portion 413. By having the screw 460C pass through the screw hole 421 and screw-engaged thereto, the reinforcing member 420 is sandwiched between a head portion 460Ca and the fastened portion 413, and a center portion in the longitudinal direction of the reinforcing member 420 is fastened to the guide main body 410. That is, there is only one fastening portion, i.e., fastening structure, provided according to the present embodiment, which is formed of the screw 460C screw-engaged to the screw hole 413a of the fastened portion 413 and the screw hole 421 of the reinforcing member 420.

Meanwhile, on each of the projected portions 414 formed to extend from the inclined portion 412, screw holes 414a to which screws 460A or screws 460B serving as first screws are engaged are formed at positions that differ from the position of the screw 460C in the longitudinal direction of the reinforcing member 420. Further, as illustrated in FIG. 8C, long holes 422 serving as first through holes are formed to pass through at positions opposed to the plurality of projected portions 414 on the upper surface 420a of the reinforcing member 420. A width of the long holes 422 in the conveyance direction V is formed narrower than a diameter of a head portion 460Ba of the screw 460B (or 460A), and a length of the long holes 422 in the width direction Y is formed longer than the projected portions 414. In other words, the head portion 460Ba of the screw 460B (or 460A) is formed wider in width than the width of the long holes 422 in the conveyance direction V. That is, the projected portions 414 are formed to pass through the long holes 422 without being fastened to the reinforcing member 420, and the leading edges thereof are formed to protrude for distance d from the surface of the distance d. Then, by having the screws 460B (or 460A) screw-engaged to the screw holes 414a of the projected portions 414, the screws 460B (or 460A) are disposed with a gap of distance d between the head portion 460Ba and the reinforcing member 420. Thereby, the reinforcing member 420 is retained to the projected portions 414 by the head portions 460Ba of the screws 460B (or 460A), and restricts the guide main body 410 and the reinforcing member 420 from separating. That is, according to the present embodiment, a plurality of restricting portions that are arranged at positions that differ from the fastening portion in the longitudinal direction and that restrict the guide main body 410 and the reinforcing member 420 from separating are formed of screws 460B (or 460A) that pass through the projected portions 414 and the long holes 422 of the reinforcing member 420.

In the present embodiment, distance d, which is the amount of projection in which the projected portions 414 protrude from the surface of the reinforcing member 420, is set to a distance corresponding to component tolerance such that the guide main body 410 and the reinforcing member 420 are not completely fastened, even while taking component tolerance into consideration, and it may be set to approximately 0.2 mm, for example.

Further, as illustrated in FIGS. 7 and 8A, the main body portion of the reinforcing member 420 excluding the washer portion 429 is divided equally into three equal parts in the width direction Y, and the parts are defined as a first end portion PA, a second end portion PB, and a center portion PC. In that case, the fastening portion, that is, the screw 460C, fastens the guide main body 410 and the center portion PC of the reinforcing member 420. Further, the restricting portions composed of the plurality of projected portions 414 include first restricting portions, that are, the screws 460A, that restrict the guide main body 410 and the first end portion PA of the reinforcing member 420 from separating. Further, the restricting portions composed of the plurality of projected portions 414 include second restricting portions, that are, the screws 460B, that restrict the guide main body 410 and the second end portion PB of the reinforcing member 420 from separating.

According to the swing guide unit 400 configured as above, the reinforcing member 420 is attached and assembled to the guide main body 410 by having the screws 460A, 460B, and 460C screw-engaged thereto. In the embodiment, the reinforcing member 420 is fastened to the guide main body 410 at one position in the width direction Y by the screw 460C with respect to the fastened portion 413. Further, the screws 460A and 460B screw-engaged to the projected portions 414 function as restricting portions that hold and restrict the guide main body 410 from separating from the reinforcing member 420. Further, by having the reinforcing member 420 come into contact with the plurality of contact portions 415, the contact portions 415 are interposed between the reinforcing member 420 and the inclined portion 412, such that the reinforcement member 420 restricts the deformation of and reinforces the guide main body 410 such that warping does not exceed distance d. In other words, by having the contact portions 415 come into contact with the reinforcing member 420, the position of the inclined portion 412 with respect to the reinforcing member 420 is determined. Thereby, warping of the guide main body 410, especially the inclined portion 412 and the white color member 440, may be corrected such that it has approximately a same flatness as the reinforcing member 420.

In other words, warping of the guide main body 410 can be corrected by the reinforcing member 420 without having the guide main body 410 and the reinforcing member 420 completely fastened at a plurality of positions. For example, if the guide main body 410 and the reinforcing member 420 are completely fastened at a plurality of positions, the guide main body 410 is expanded greater than the reinforcing member 420 due to the difference of thermal expansion coefficients of resin and metal, especially in a case where the surrounding environmental temperature rises. Then, the guide main body 410 may be deformed in a manner enclosing the narrow space PSa of the conveyance path PS at portions corresponding to the plurality of fastened positions, which may lead to skewing of the document D due to increased friction or jamming of sheets.

Therefore, by adopting a configuration of the swing guide unit 400 as according to the present embodiment described above, it may be possible to suppress the deterioration of positional accuracy of the swing guide unit 400 with respect to the document feeding-reading glass 312 caused by the influence of component tolerance or influence of deformation due to environmental changes. Thus, deterioration of quality of read image of the document D1 may be suppressed.

### Other Possible Modifications

According to the present embodiment described above, an example in which the restricting portions, i.e., the screws 460A and 460B, are aligned and disposed at a plurality of positions in the width direction Y was described, but the present technique is not limited thereto, and as long as the restricting portion is disposed at one position or more, the reinforcing function of the reinforcing member 420 can be achieved.

According further to the present embodiment, a configuration in which the restricting portions are composed of the screws 460A and 460B has been described, but the resent technique is not limited thereto. For example, a snap-fit that is passed through a long hole may be adopted. Further, the configuration is not limited to having a long hole, and for example, a configuration in which a hook-like member is protruded above the upper surface of the reinforcing member 420 to prevent separation from the guide main body 410 may be adopted. That is, any structure may be adopted as long as the structure prevents the reinforcing member 420 from separating from the guide main body 410.

According further to the present embodiment, a configuration in which the reinforcing member 420 and the guide main body 410 are fastened by the screw 460C serving as the fastening portion was described. However, the present technique is not limited thereto, and any means capable of fastening the reinforcing member 420 and the guide main body 410 may be adopted, such as bonding, riveting, or caulking.

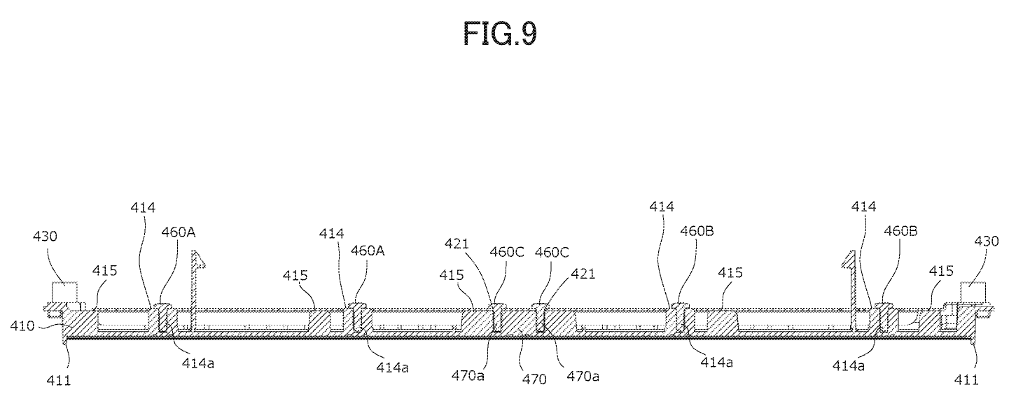

According further to the present embodiment, a configuration in which the reinforcing member 420 and the guide main body 410 are fastened by one screw 460C was described. However, the present technique is not limited thereto. As illustrated in FIG. 9, the reinforcing member 420 and the guide main body 410 may be fastened by a plurality of screws 460C. The plurality of screws 460C are disposed on a center projected portion 470 in a longitudinal direction, i.e., width direction Y, of the reinforcing member 420. The center projected portion 470 is a projected portion positioned at a center in the longitudinal direction among the plurality of projected portions disposed on the guide main body 410. In other words, the center projected portion 470 is a projected portion disposed between the projected portions 414 on which the screws 460A are attached and the projected portions 414 on which the screws 460B are attached in the longitudinal direction. A plurality of screw holes 470a to which a plurality of screws 460C described above are to be screw-engaged are formed on the center projected portion 470, which serve as fastened portions to which the screws 460C serving as fastening portions are fastened. By disposing a plurality of fastening portions at such adjacent areas, fastening force of the reinforcing member 420 and the guide main body 410 can be enhanced while suppressing the influence caused by the different thermal expansion coefficients of resin and metal, as described in the embodiment illustrated above. The center projected portion 470 is included in the area of the center portion PC illustrated in FIGS. 7 and 8A.

According even further to the present embodiment, a configuration in which the contact portions 415 come into contact with the reinforcing member 420 in a state where the reinforcing member 420 is attached to the guide main body 410 was described. However, the present technique is not limited thereto, and the reinforcing member 420 being attached to the guide main body 410 is not necessary in contact therewith, and it may be spaced apart by taking tolerance into consideration. That is, the contact portion is configured such that the guide main body 410 comes into contact with the reinforcing member 420 at least when the guide main body 410 is deformed.

According further to the present embodiment, a configuration in which the washer portion 429 is formed integrally with the reinforcing member 420 and electrically conducted with the springs 430 was described. However, the present technique is not limited thereto, and the reinforcing member 420 may be configured separately as the washer portion 429, that is, any configuration may be adopted as long as the reinforcing member 420 is electrically connected to the washer portion 429 and the urging force of the springs 430 act on the guide main body 410.

Further according to the present embodiment, a configuration in which a plurality of driven rollers 450 and 451 are disposed on the guide main body 410 has been described, but the present technique is not limited thereto. For example, a configuration in which the guide main body 410 is not equipped with a driven roller, or in which the guide main body 410 includes only either the driven roller 450 or the driven roller 4501 may be adopted.

Further according to the present embodiment, a configuration in which the ADF 102 serving as a sheet conveyance apparatus is equipped with the swing guide unit 400 which is arranged to be opposed to the document feeding-reading glass 312 was described. However, the present technique is not limited thereto, and the sheet conveyance apparatus may be an image forming apparatus, a fixing unit, a drying apparatus, a reversing apparatus, or a processing apparatus. For example, any sheet conveyance apparatus configured to allow a sheet to pass through between an opposing unit and a transparent member for reading an image on a sheet, such as a configuration where an image on a sheet to which an image has been formed is to be inspected, may be adopted.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-076833, filed May 2, 2025, and Japanese Patent Application No. 2026-38079 filed Mar. 10, 2026 which are hereby incorporated by reference herein in their entirety.

What is claimed is:

1. A sheet conveyance apparatus comprising:
a conveyance portion including a conveyance path configured to guide a sheet being conveyed such that the sheet passes through a reading position of a reading portion at which an image on the sheet is read via a transparent member, and an opposing unit arranged to be opposed to the transparent member and configured to form a portion of the conveyance path,
wherein the opposing unit includes:
a guide main body made of resin and including an opposing portion arranged to be opposed to a surface of the transparent member;
a reinforcing member made of metal, configured to extend in a longitudinal direction of the guide main body, and attached to the guide main body on an opposite side from the transparent member;
a single fastening portion configured to fasten the guide main body and the reinforcing member; and
a restricting portion configured to restrict the guide main body and the reinforcing member from separating,
wherein the fastening portion is disposed at one location, and the restricting portion disposed at a position different from the fastening portion in the longitudinal direction.

2. The sheet conveyance apparatus according to claim 1, wherein the restricting portion is one of a plurality of restricting portions and the plurality of restricting portions are arranged at a plurality of different positions respectively different from the fastening portion in the longitudinal direction.

3. The sheet conveyance apparatus according to claim 2,
wherein the reinforcing member includes a plurality of first through holes,
wherein the guide main body includes a plurality of projected portions protruded in a direction opposing to the reinforcing member, and
wherein the plurality of restricting portions includes a plurality of first screws each including a head portion having a width wider than a width of corresponding first through hole and being disposed to pass through the first through hole to be screw-engaged to the projected portions, such that there is a gap between the head portion and the reinforcing member.

4. The sheet conveyance apparatus according to claim 2,
wherein the reinforcing member includes a first end portion, a second end portion, and a center portion disposed between the first end portion and the second end portion, which are arranged in the longitudinal direction of the reinforcing member,
wherein the fastening portion is configured to fasten the guide main body and the center portion of the reinforcing member, and
wherein the restricting portions include a first restricting portion configured to restrict the guide main body and the first end portion of the reinforcing member from separating, and a second restricting portion configured to restrict the guide main body and the second end portion of the reinforcing member from separating.

5. The sheet conveyance apparatus according to claim 2, wherein the guide main body includes a plurality of contact portions that are disposed at a plurality of positions in the longitudinal direction so as to be interposed between the reinforcing member and the opposing portion, and that are configured to determine a position of the opposing portion with respect to the reinforcing member by being in contact with the reinforcing member.

6. The sheet conveyance apparatus according to claim 1,
wherein the reinforcing member includes a second through hole ,
wherein the guide main body includes a fastened portion configured to be in contact with a circumference of the second through hole in a state where the reinforcing member is attached thereto, and
wherein the fastening portion includes a second screw including a head portion having a width wider than a width of the second through hole and being disposed to pass through the second through hole to be screw-engaged to the fastened portion, such that the guide main body and the reinforcing member are fastened with the reinforcing member sandwiched between the head portion and the fastened portion.

7. The sheet conveyance apparatus according to claim 1,
wherein the reinforcing member includes a first through hole formed to pass through the reinforcing member and a second through hole formed to pass through the reinforcing member,
wherein the guide main body includes a projected portion passing through and projected from the first through hole in a state where the reinforcing member is attached to the guide main body, and a fastened portion configured to be in contact with a circumference of the second through hole in a state where the reinforcing member is attached to the guide main body,
wherein the restricting portion includes a first screw including a head portion having a width wider than a width of the first through hole and being disposed to be screw-engaged to the projected portion projected than the first through hole, such that there is a gap between the head portion and the reinforcing member, and
wherein the fastening portion includes a second screw including a head portion having a width wider than a width of the second through hole and being disposed to pass through the second through hole to be screw-engaged to the fastened portion, such that the guide main body and the reinforcing member are fastened with the reinforcing member sandwiched between the head portion and the fastened portion.

8. The sheet conveyance apparatus according to claim 1, wherein the guide main body includes abutment portions that are arranged on outer sides of the opposing portion in the longitudinal direction and that are abutted against the transparent member to form a conveyance space through which a sheet passes.

9. The sheet conveyance apparatus according to claim 8, further comprising an urging portion that urges the opposing portion toward the transparent member.

10. The sheet conveyance apparatus according to claim 9,
wherein the urging portion is a spring made of metal that is conducted with a member on which a first end of the spring is disposed, and
wherein the reinforcing member includes a conduction portion that is electrically conducted with a second end of the spring.

11. The sheet conveyance apparatus according to claim 1, wherein the opposing unit includes a white color member having a plate shape that is disposed on the opposing portion.

12. The sheet conveyance apparatus according to claim 1, wherein the guide main body includes a rotary member that is arranged adjacent to the opposing portion in a conveyance direction of the sheet and configured to be rotated by the sheet being conveyed.

13. The sheet conveyance apparatus according to claim 12, wherein the rotary member includes a first rotary member disposed upstream of the opposing portion in the conveyance direction and a second rotary member disposed downstream of the opposing portion in the conveyance direction.

14. An image reading apparatus, comprising:
the sheet conveyance apparatus according to claim 1; and
an image reading portion including the transparent member and the reading portion,
wherein the sheet conveyance apparatus is a document conveyance apparatus including:
a document supporting portion configured to support a document;
the conveyance portion configured to convey a document supported on the document supporting portion; and
a discharged document supporting portion configured to support a document discharged from the conveyance portion.

15. An image forming apparatus comprising:
the image reading apparatus according to claim 14, and
an image forming unit configured to form an image on a sheet.

16. A sheet conveyance apparatus comprising:
a conveyance portion including a conveyance path configured to guide a sheet being conveyed such that the sheet passes through a reading position of a reading portion at which an image on the sheet is read via a transparent member, and an opposing unit arranged to be opposed to the transparent member and configured to form a portion of the conveyance path,
wherein the opposing unit includes:
a guide main body made of resin and including an opposing portion arranged to be opposed to a surface of the transparent member;
a reinforcing member made of metal, configured to extend in a longitudinal direction of the guide main body, and attached to the guide main body on an opposite side from the transparent member;
a fastening portion configured to fasten the guide main body and the reinforcing member; and
a first and second restricting portions disposed at positions respectively different from the fastening portion in the longitudinal direction and configured to restrict the guide main body and the reinforcing member from separating,
wherein the reinforcing member includes a first end portion, a second end portion, and a center portion disposed between the first end portion and the second end portion, which are arranged in the longitudinal direction of the reinforcing member,
wherein the fastening portion is configured to fasten the guide main body and the center portion of the reinforcing member, and
wherein the first restricting portion is configured to restrict the guide main body and the first end portion of the reinforcing member from separating, and the second restricting portion is configured to restrict the guide main body and the second end portion of the reinforcing member from separating.

17. The sheet conveyance apparatus according to claim 16,
wherein the reinforcing member includes first through holes formed to pass through the reinforcing member,
wherein the guide main body includes projected portions protruded in a direction opposing to the reinforcing member, and
wherein each of the first and second restricting portions includes a first screw including a head portion having a width wider than a width of a corresponding first through hole and being disposed to pass through the first through hole to be screw-engaged to the projected portion, such that there is a gap between the head portion and the reinforcing member.

18. The sheet conveyance apparatus according to claim 16,
wherein the reinforcing member includes a second through hole configured to pass through the reinforcing member,
wherein the guide main body includes a center projected portion configured to protrude toward a direction opposing to the reinforcing member, and
wherein the fastening portion includes a second screw including a head portion having a width wider than a width of the second through hole and being disposed to pass through the second through hole to be screw-engaged to the center projected portion, such that the guide main body and the reinforcing member are fastened with the reinforcing member sandwiched between the head portion and the center projected portion.

19. An image reading apparatus, comprising:
the sheet conveyance apparatus according to Claims claim 16; and
an image reading portion including the transparent member and the reading portion,
wherein the sheet conveyance apparatus is a document conveyance apparatus including:
a document supporting portion configured to support a document;
the conveyance portion configured to convey a document supported on the document supporting portion; and
a discharged document supporting portion configured to support a document discharged from the conveyance portion.

20. An image forming apparatus comprising:
the image reading apparatus according to claim 19, and
an image forming unit configured to form an image on a sheet.
